(19) United States
(12) Patent Application Publication
(10) Pub. No.: US 2026/0029535 A1
(43) Pub. Date: Jan. 29, 2026

(54) DISTANCE IMAGE CAPTURING DEVICE AND DISTANCE IMAGE CAPTURING METHOD

(71) Applicant: TOPPAN Holdings Inc., Tokyo (JP)

(72) Inventors: Yuya SHIRAKAWA, Tokyo (JP); Kazuto YAMAMOTO, Tokyo (JP)

(73) Assignee: TOPPAN Holdings Inc., Tokyo (JP)

(21) Appl. No.: 19/278,165

(22) Filed: Jul. 23, 2025

(30) Foreign Application Priority Data
Jul. 29, 2024 (JP) 2024-122341

(51) Int. Cl. G01S 17/89; G01S 17/10; G06T 7/70; H04N 25/57; H04N 25/76; H04N 25/77

(52) U.S. Cl. CPC G01S 17/89; G01S 17/10; G06T 7/70; H04N 25/57; H04N 25/77; H04N 25/7795

(57) ABSTRACT

A distance image processing unit performs pre-measurement by a driving method that allows calculation of a distance and a reflectivity of a subject present in a measurement space, calculates the distance to the subject and the reflectivity of the subject as a situation of the subject present in the measurement space based on a measurement result of the pre-measurement, performs main measurement based on the situation of the subject present in the measurement space, and selects, in the main measurement, whether to perform high dynamic range (HDR) driving that expands the measurement range or to perform normal driving that does not expand the measurement range, based on the situation.

### CROSS REFERENCE TO RELATED APPLICATIONS

This application claims the benefit of priority based on Japanese Patent Application No. 2024-122341, filed on Jul. 29, 2024, in the Japan Patent Office. The contents of the Japanese Patent Application are incorporated herein by reference.

### BACKGROUND OF THE INVENTION

### Field of the Invention

The present disclosure relates to a distance image capturing device and a distance image capturing method.

### Description of Related Art

A time of flight (hereinafter, referred to as “TOF”) type distance image capturing device has been implemented that uses a known speed of light and measures a distance between a measuring instrument and a target object based on a flight time of light in a measurement space (for example, refer to Japanese Patent No. 4235729).

In such a distance image capturing device, a driving method using high dynamic range (HDR) driving that expands a measurement range without reducing measurement accuracy has been proposed. For example, PCT International Publication No. WO2019/078366A discloses a technology for improving a dynamic range of distance measurement by performing driving such that saturation of a pixel signal is suppressed in a case where a subject at a short distance is a target to be measured and the ratio of noise included in the pixel signal is suppressed in a case where a subject at a long distance is a target to be measured. In addition, Japanese Patent No. 4235729B discloses a technology of performing distance measurement in which a dynamic range is expanded by using a frame in which distance measurement is performed by imaging with long-term exposure and a frame in which distance measurement is performed by imaging with short-term exposure.

### SUMMARY OF THE INVENTION

However, in a case where the HDR driving is performed even though it is not necessary to expand the measurement range, the time required for the measurement is increased in many cases compared to a case where the HDR driving is not performed, and the effect cannot be maximized.

The present disclosure has been made to solve the above-described problem, and an object of the present disclosure is to provide a distance image capturing device and a distance image capturing method capable of appropriately using HDR driving that is a driving method of expanding a measurement range.

According to an aspect of the present disclosure, there is provided a distance image capturing device, which includes a light source unit configured to emit an optical pulse to a measurement space; a light receiving unit including a pixel circuit in which a plurality of pixels are arranged in a two-dimensional matrix, each pixel having a photoelectric conversion element that generates charges according to incident light and a plurality of charge accumulation units that accumulate the charges, and a pixel drive circuit that distributes and accumulates the charges in each of the charge accumulation units at a predetermined accumulation timing synchronized with an emission timing at which the optical pulse is emitted; and a distance image processing unit configured to calculate a distance to a subject present in the measurement space based on an amount of the charges accumulated in each of the charge accumulation units. The distance image processing unit performs pre-measurement by a driving method that allows calculation of the distance and a reflectivity of the subject present in the measurement space, calculates the distance to the subject and the reflectivity of the subject as a situation of the subject present in the measurement space based on a measurement result of the pre-measurement, performs main measurement based on the situation of the subject present in the measurement space, and selects, in the main measurement, whether to perform high dynamic range (HDR) driving that expands a measurement range or to perform normal driving that does not expand the measurement range, based on the situation.

According to another aspect of the present disclosure, there is provided a distance image capturing method performed using a distance image capturing device including a light source unit configured to emit an optical pulse to a measurement space; a light receiving unit including a pixel circuit in which a plurality of pixels are arranged in a two-dimensional matrix, each pixel having a photoelectric conversion element that generates charges according to incident light and a plurality of charge accumulation units that accumulate the charges, and a pixel drive circuit that distributes and accumulates the charges in each of the charge accumulation units at a predetermined accumulation timing synchronized with an emission timing at which the optical pulse is emitted; and a distance image processing unit configured to calculate a distance to a subject present in the measurement space based on an amount of the charges accumulated in each of the charge accumulation units. The distance image processing unit performs pre-measurement by a driving method that allows calculation of the distance and a reflectivity of the subject present in the measurement space, calculates the distance to the subject and the reflectivity of the subject as a situation of the subject present in the measurement space based on a measurement result of the pre-measurement, performs main measurement based on the situation of the subject present in the measurement space, and selects, in the main measurement, whether to perform high dynamic range (HDR) driving that expands a measurement range or to perform normal driving that does not expand the measurement range, based on the situation.

According to the present disclosure, the HDR driving can be appropriately used.

### BRIEF DESCRIPTION OF THE DRAWINGS

FIG. 1 is a block diagram showing an example configuration of a distance image capturing device 1 according to an embodiment.

FIG. 2 is a block diagram showing an example configuration of a distance image sensor 32 according to the embodiment.

FIG. 3 is a circuit diagram showing an example configuration of a pixel 321 according to the embodiment.

FIG. 4 is a diagram showing normal driving performed by a distance image processing unit 4 according to the embodiment.

FIG. 5 is a diagram showing first HDR driving performed by the distance image processing unit 4 according to the embodiment.

FIG. 6 is a diagram showing second HDR driving performed by the distance image processing unit 4 according to the embodiment.

FIG. 7 is a diagram showing third HDR driving performed by the distance image processing unit 4 according to the embodiment.

FIG. 8 is a diagram showing processing performed by the distance image processing unit 4 according to the embodiment.

FIG. 9 is a diagram showing the processing performed by the distance image processing unit 4 according to the embodiment.

FIG. 10 is a diagram showing the processing performed by the distance image processing unit 4 according to the embodiment.

FIG. 11 is a diagram showing the processing performed by the distance image processing unit 4 according to the embodiment.

FIG. 12 is a diagram showing the processing performed by the distance image processing unit 4 according to the embodiment.

FIG. 13 is a flowchart showing a flow of the processing performed by the distance image processing unit 4 according to the embodiment.

FIG. 14 is a diagram showing first combination driving performed by the distance image processing unit 4 according to the embodiment.

### DETAILED DESCRIPTION OF THE INVENTION

Hereinafter, a distance image capturing device of an embodiment will be described with reference to the drawings.

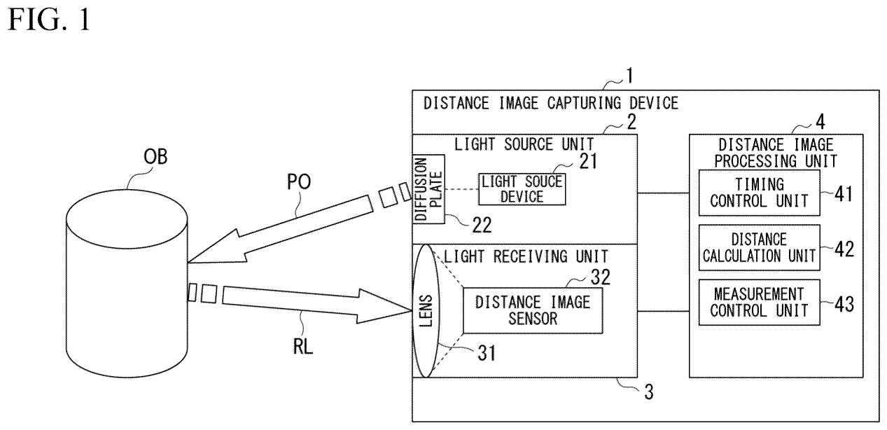

FIG. 1 is a block diagram showing a schematic configuration of a distance image capturing device according to an embodiment. For example, the distance image capturing device 1 includes a light source unit 2, a light receiving unit 3, and a distance image processing unit 4. FIG. 1 also shows a subject OB that is a target object to which the distance image capturing device 1 measures the distance thereto.

The light source unit 2 emits an optical pulse PO to the subject OB under the control of the distance image processing unit 4. For example, the light source unit 2 is a surface emitting semiconductor laser module such as a vertical cavity surface emitting laser (VCSEL). The light source unit 2 includes a light source device 21 and a diffusion plate 22.

A light source device 21 is a light source that emits laser light in a near-infrared wavelength band (for example, a wavelength band with a wavelength of 850 nm to 940 nm) as the optical pulse PO to be emitted to the subject OB. The light source device 21 is, for example, a semiconductor laser light emitting element. The light source device 21 emits pulsed laser light under the control of a timing control unit 41.

The diffusion plate 22 is an optical component that diffuses the laser light in the near-infrared wavelength band emitted by the light source device 21 to a size of a surface for emitting the laser light to the subject OB. The pulsed laser light diffused by the diffusion plate 22 is emitted as the optical pulse PO, and emitted to the subject OB.

The light receiving unit 3 receives reflected light RL of the optical pulse PO reflected by the subject OB and outputs a pixel signal corresponding to the received reflected light RL. The light receiving unit 3 includes a lens 31 and a distance image sensor 32.

The lens 31 is an optical lens that guides the incident reflected light RL to the distance image sensor 32. The lens 31 emits the incident reflected light RL to the distance image sensor 32 side, and causes the reflected light RL to be received by (incident on) pixels provided in the light receiving region of the distance image sensor 32.

The distance image sensor 32 is an imaging element. The distance image sensor 32 is provided with a plurality of pixels arranged in a two-dimensional matrix. In each of the pixels of the distance image sensor 32, one photoelectric conversion element, a plurality of charge accumulation units corresponding to the one photoelectric conversion element, and a component that distributes the charges to each of the charge accumulation units are provided. That is, the pixel is the imaging element having a distribution configuration in which the charges are distributed and accumulated in the plurality of charge accumulation units.

The distance image sensor 32 distributes the charges generated by the photoelectric conversion element to each of the charge accumulation units under the control of the timing control unit 41. In addition, the distance image sensor 32 outputs the pixel signal corresponding to the amount of charges distributed to the charge accumulation unit. A plurality of pixels are arranged in a two-dimensional matrix in the distance image sensor 32, and a pixel signal that corresponds to one frame corresponding to each pixel is output.

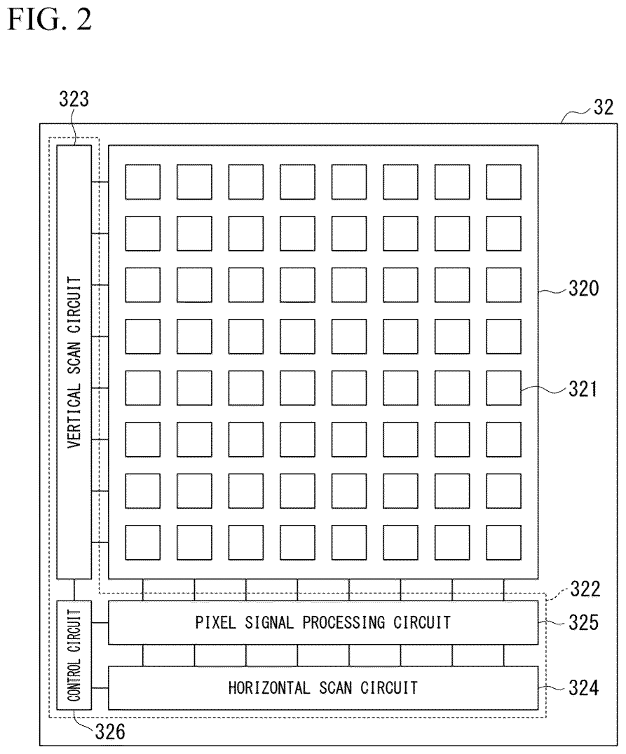

Here, the configuration of the distance image sensor 32 will be described with reference to FIG. 2. FIG. 2 is a block diagram showing a schematic configuration of the imaging element (distance image sensor 32) used in the distance image capturing device 1 according to the embodiment.

As shown in FIG. 2, for example, the distance image sensor 32 includes a light receiving region 320 in which a plurality of pixels 321 are arranged in a two-dimensional matrix, and a pixel drive circuit 322. For example, the pixel drive circuit 322 is provided with a vertical scan circuit 323 having a distribution operation, a horizontal scan circuit 324, a pixel signal processing circuit 325, and a control circuit 326.

The light receiving region 320 is a region in which the plurality of pixels 321 are arranged in a two-dimensional matrix, and FIG. 2 shows an example in which the plurality of pixels 321 are arranged in a two-dimensional matrix of eight rows and eight columns. The pixel 321 accumulates the charges corresponding to the received amount of light and outputs an accumulation signal corresponding to the accumulated amount of charges.

The control circuit 326 collectively controls the distance image sensor 32. For example, the control circuit 326 controls operations of components of the distance image sensor 32 in response to an instruction from the timing control unit 41 of the distance image processing unit 4. The components provided in the distance image sensor 32 may be controlled directly by the timing control unit 41, and in this case, the control circuit 326 can also be omitted.

The vertical scan circuit 323 controls the pixels 321 arranged in the light receiving region 320 for each row under the control of the control circuit 326. The vertical scan circuit 323 outputs a voltage signal corresponding to the amount of the charges accumulated in each of the charge accumulation units CS of the pixel 321 to the pixel signal processing circuit 325. For example, the vertical scan circuit 323 distributes the charges converted by a photoelectric conversion element to each of the charge accumulation units of the pixel 321 at an accumulation timing synchronized with the emission of the optical pulse PO and accumulates therein. In addition, the vertical scan circuit 323 discharges the charges converted by the photoelectric conversion element from a charge discharge unit (a drain gate transistor GD to be described below) in a period (for example, a readout period) different from an accumulation period in which charges are accumulated in the charge accumulation unit CS.

The pixel signal processing circuit 325 performs predetermined signal processing (for example, noise suppression processing, A/D conversion processing, or the like) for a voltage signal output to a corresponding vertical signal line from the pixels 321 in each of the columns under the control of the control circuit 326.

The horizontal scan circuit 324 sequentially outputs signals output from the pixel signal processing circuit 325 in time series under the control of the control circuit 326. As a result, an accumulation signal in one frame is sequentially output to the distance image processing unit 4. The following will be described assuming that the pixel signal processing circuit 325 performs A/D conversion processing and the accumulation signal is a digital signal.

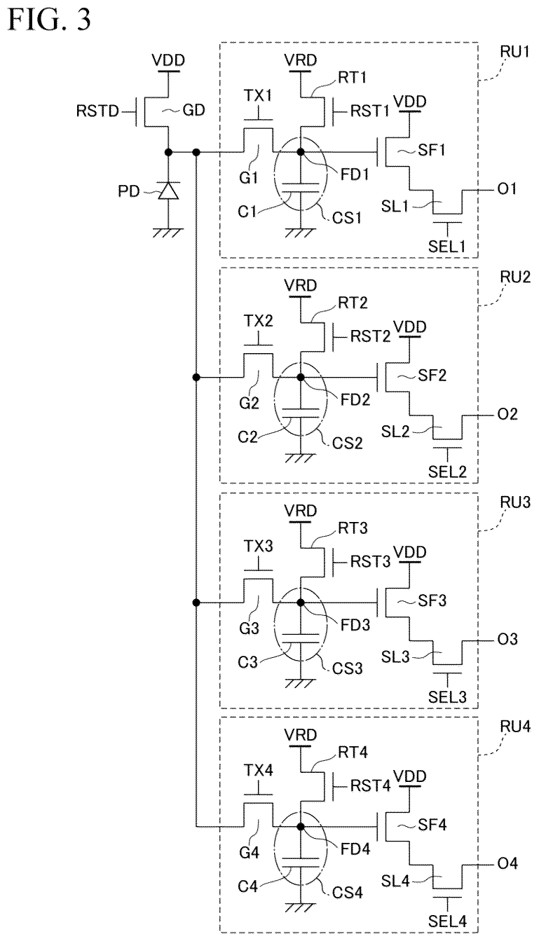

Here, the configuration of the pixel 321 will be described with reference to FIG. 3. FIG. 3 is a circuit diagram showing an example of the pixel 321. FIG. 3 shows an example of the configuration of one pixel 321 among the plurality of pixels 321 arranged in the light receiving region 320. In this figure, an example in which the pixel 321 is provided with four signal readout units RU (signal readout units RU1 to RU4) is shown.

The pixel 321 includes one photoelectric conversion element PD, a drain gate transistor GD, and four signal readout units RU each of which outputs a voltage signal from a corresponding output terminal O. Each of the signal readout units RU includes a readout gate transistor G, a floating diffusion FD, a charge accumulation capacitor C, a reset transistor RT, a source follower transistor SF, and a selection transistor SL. The charge accumulation unit CS includes the floating diffusion FD and the charge accumulation capacitor C.

In FIG. 3, each of the signal readout units RU is distinguished by assigning any one number of “1” to “4” after the reference numeral “RU” of the four signal readout units RU. In addition, similarly, each of the components included in the four signal readout units RU is also represented by distinguishing the signal readout units RU corresponding to each of the components by indicating the number representing each signal readout unit RU after the reference numeral.

In the pixel 321, the signal readout unit RU1 outputs a voltage signal from an output terminal O1. The signal readout unit RU1 includes a readout gate transistor G1, a floating diffusion FD1, a charge accumulation capacitor C1, a reset transistor RT1, a source follower transistor SF1, and a selection transistor SL1. The charge accumulation unit CS1 is configured with the floating diffusion FD1 and the charge accumulation capacitor C1. Signal readout units RU2 to RU4 also have the same configuration.

The photoelectric conversion element PD is an embedded photodiode that photoelectrically converts incident light to generate the charge corresponding to the intensity of the incident light and accumulates the generated charge. The photoelectric conversion element PD may have any structure. The photoelectric conversion element PD may be, for example, a PN photodiode having a structure in which a P-type semiconductor and an N-type semiconductor are bonded together or a PIN photodiode having a structure in which an I-type semiconductor is interposed between the P-type semiconductor and the N-type semiconductor. In addition, the photoelectric conversion element PD is not limited to a photodiode, and may be, for example, a photogate-type photoelectric conversion element.

The drain gate transistor GD is a transistor for discarding the charge generated in the photoelectric conversion element PD. When the drain gate transistor GD is controlled to be turned on by the pixel drive circuit 322, the drain gate transistor GD discards the charges generated in the photoelectric conversion element PD (that is, resets the photoelectric conversion element PD).

The pixel drive circuit 322 drives the pixel 321, distributes the charges generated by photoelectrically converting incident light by using the photoelectric conversion element PD to each of the four charge accumulation units CS, and outputs each of voltage signals corresponding to the amount of charges of the distributed charges to the pixel signal processing circuit 325.

For example, in driving the pixel 321, the pixel drive circuit 322 controls accumulation drive signals TX1 to TX4 corresponding to each of the charge accumulation units CS1 to CS4 to be turned on sequentially in synchronization with an emission timing of the optical pulse PO. This causes the readout gate transistors G1 to G4 corresponding to each of the charge accumulation units CS to be sequentially turned on, thereby distributing and accumulating charges in the corresponding charge accumulation units CS. As a result, the charges are sequentially accumulated in the charge accumulation units CS1, CS2, CS3, and CS4.

The pixel 321 is not limited to the configuration including the four signal readout units RU as shown in FIG. 3, and may be a pixel configured to include a plurality of signal readout units RU. That is, the number of signal readout units RU (charge accumulation units CS) included in the pixels arranged in the distance image sensor 32 may be two, three, or five or more.

In addition, FIG. 3 shows an example in which the charge accumulation unit CS is configured by the floating diffusion FD and the charge accumulation capacitor C. However, the charge accumulation unit CS may be configured by at least the floating diffusion FD, and the pixel 321 may not include the charge accumulation capacitor C.

Returning to the description of FIG. 1, the distance image processing unit 4 controls the distance image capturing device 1 to calculate the distance to the subject OB. The distance image processing unit 4 is provided with the timing control unit 41, a distance calculation unit 42, and a measurement control unit 43.

The timing control unit 41 controls the timing when various control signals required for measurement are output under the control of the measurement control unit 43. Here, the various control signals include, for example, a signal that controls the emission of the optical pulse PO, a signal that distributes and accumulates the reflected light RL in the plurality of charge accumulation units, a signal that controls the number of times of integration per frame, and the like.

The number of times of integration is the number of times that the processing of distributing and accumulating charges in the charge accumulation units CS (refer to FIG. 3) is repeated per frame. The product of the number of times of integration and the time (accumulation time) for accumulating charges in each charge accumulation unit in one time of processing of distributing and accumulating the charges is the exposure time per frame.

The distance calculation unit 42 outputs distance information obtained by calculating the distance to the subject OB based on the pixel signal output from the distance image sensor 32. The distance calculation unit 42 calculates a delay time from emitting the optical pulse PO to receiving the reflected light RL, based on the amount of the charges accumulated in the plurality of charge accumulation units. The distance calculation unit 42 calculates the distance to the subject OB in accordance with the calculated delay time.

The distance calculation unit 42 calculates delay time Td, for example, by the following Expression (1). In addition, in Expression (1), it is assumed that the amount of charges of a certain amount of fixed pattern noise (FPN) that is included in the amount of the charges accumulated in the charge accumulation units CS1 and CS2 and does not depend on the number of times of integration is the same as the amount of charges accumulated in the charge accumulation unit CS3.

$$Td = To \times ( Q 2 - Q 3 ) / ( Q 1 + Q 2 - 2 \times Q 3 ) \qquad ( 1 )$$

Here, To is a period during which the optical pulse PO is emitted.
Q1 is the amount of the charges accumulated in the charge accumulation unit CS1.
Q2 is the amount of the charges accumulated in the charge accumulation unit CS2.
Q3 is the amount of the charges accumulated in the charge accumulation unit CS3.

In the short-distance light receiving pixel, the distance calculation unit 42 multiplies the delay time Td calculated by Expression (1) by the speed of light (speed) to calculate the round-trip distance to the subject OB. Then, the distance calculation unit 42 divides the calculated round-trip distance by half to measure the distance to the subject OB.

The measurement control unit 43 controls the timing control unit 41. For example, the measurement control unit 43 sets the number of times of integration and the accumulation time in one frame, and controls the timing control unit 41 such that an image is captured with the set contents.

With such a configuration, in the distance image capturing device 1, the light receiving unit 3 receives the reflected light RL in which the optical pulse PO in the near-infrared wavelength band emitted to the subject OB by the light source unit 2 is reflected by the subject OB, and the distance image processing unit 4 calculates the distance to the subject OB and outputs the distance information.

Although FIG. 1 shows the distance image capturing device 1 having a configuration in which the distance image processing unit 4 is provided in the distance image capturing device 1, the distance image processing unit 4 may be a component provided outside the distance image capturing device 1.

In the present embodiment, the distance image processing unit 4 performs two measurements: a pre-measurement and a main measurement. Based on the measurement result by the pre-measurement, the selection of the driving method in the main measurement and the number of times of integration in the selected driving method are determined.

Here, a relationship between the pre-measurement and the main measurement may be set as desired. For example, the pre-measurement and the main measurement may be alternately repeated, or the pre-measurement may be performed once and then the main measurement may be repeatedly performed a plurality of times. In addition, the selection of the driving method in the next main measurement and the number of times of integration in the selected driving method may be configured to be determined based on the measurement result in the main measurement.

The pre-measurement is measurement performed to grasp a situation of the subject OB present in a measurement space. The situation of the subject OB here is the position and the reflectivity of each subject OB present in the measurement space.

In the pre-measurement, the pixel 321 is driven such that a relatively wide range from a short distance to a long distance is a measurement range. The distance image processing unit 4 performs a plurality of measurements having different exposure times as the pre-measurement. For example, the distance image processing unit 4 performs measurements having different exposure times in units of frames or sub-frames as the pre-measurement. Alternatively, the distance image processing unit 4 may perform measurements having different exposure times in units of pixels as the pre-measurement.

In the pre-measurement, a plurality of measurements having different exposure times may be performed, and measurement may be performed by the same driving as the second HDR driving or the third HDR driving described below, or may be performed by different driving.

The distance image processing unit 4 calculates the position and the reflectivity of each subject OB present in the measurement space based on the measurement result by the pre-measurement.

The main measurement is measurement corresponding to the position and the reflectivity of each subject OB present in the measurement space.

In the main measurement, measurement is performed by a driving method selected from four driving methods (normal driving, first HDR driving, second HDR driving, and third HDR driving). The processing of selecting the driving method in the main measurement will be described in detail below.

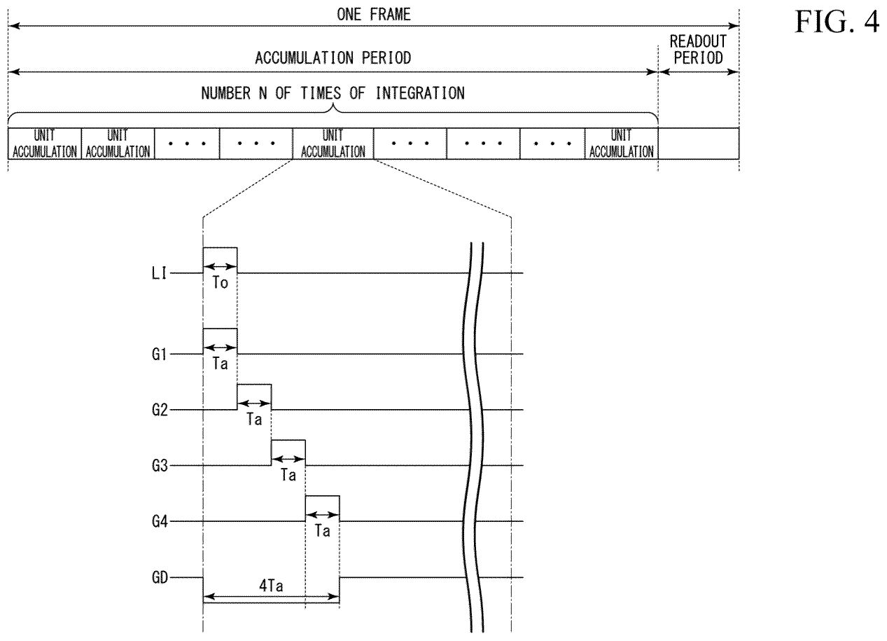

The normal driving is driving in which charges are accumulated such that the number of times of integration in each of the plurality of charge accumulation units CS included in the pixel 321 is the same (refer to FIG. 4).

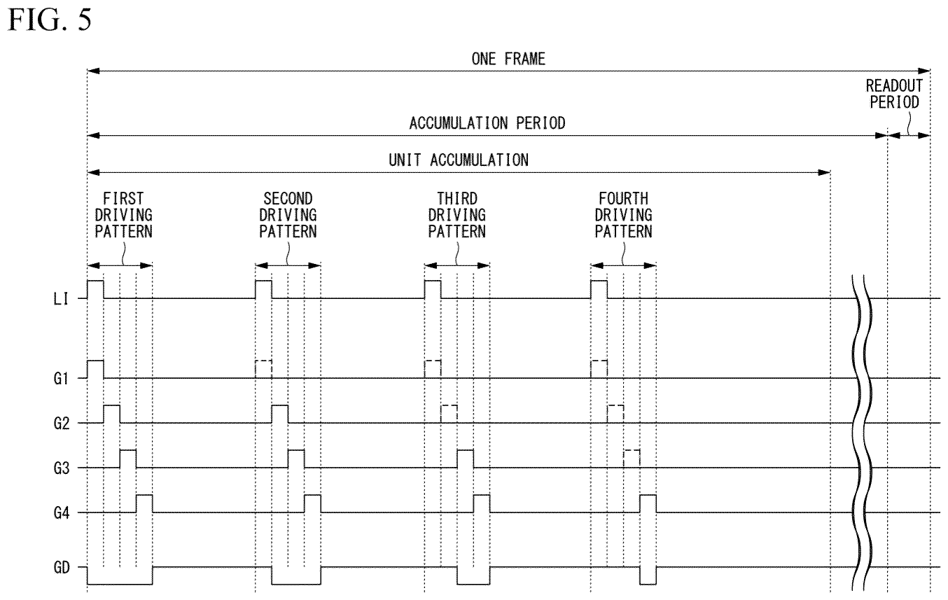

The first HDR driving is a driving method of driving the pixel 321 such that, among the plurality of charge accumulation units CS included in the pixel 321, the number of times of integration of the charge accumulation unit CS that receives the reflected light RL from the subject at a long distance is greater than the number of times of integration of the charge accumulation unit CS that receives the reflected light RL from the subject at a short distance (refer to FIG. 5).

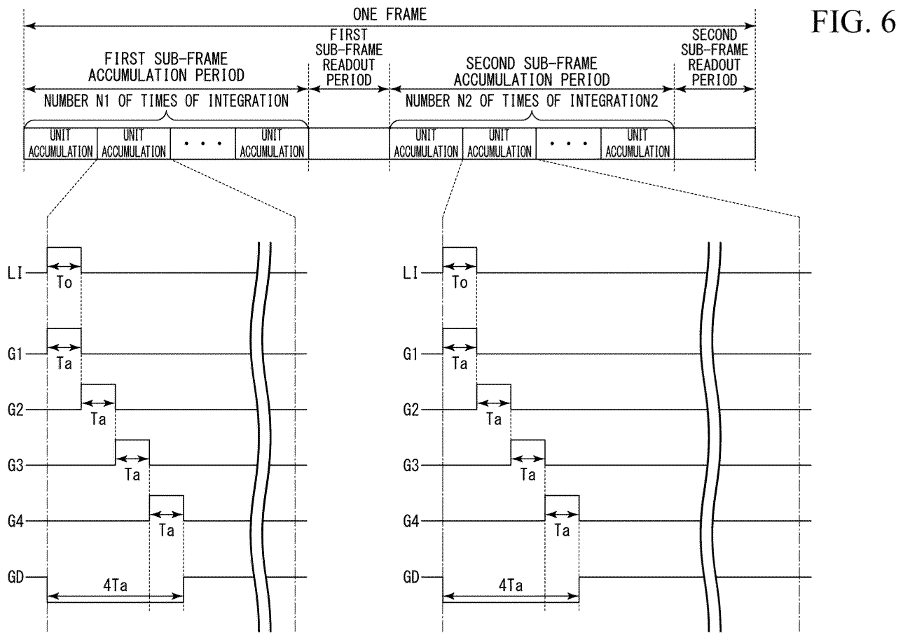

The second HDR driving is a driving method of performing measurements having different numbers of times of integration in units of frames or sub-frames (refer to FIG. 6).

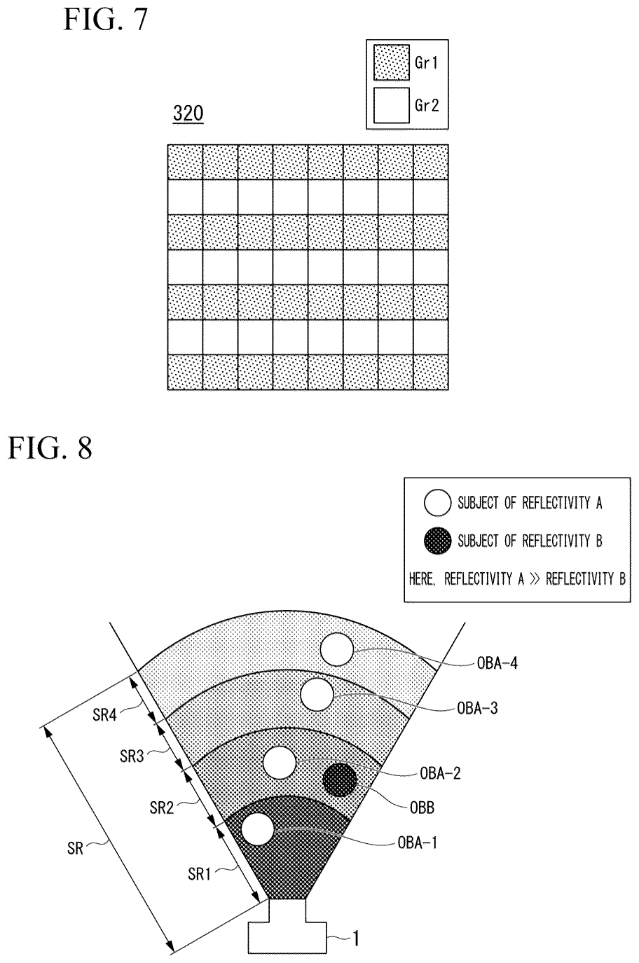

The third HDR driving is a driving method of performing measurements having different numbers of times of integration in units of pixels (refer to FIG. 7).

Here, the normal driving will be described with reference to FIG. 4. FIG. 4 is a diagram showing the normal driving performed by the distance image processing unit 4 according to the embodiment. FIG. 4 shows an example of a timing chart in which the pixel 321 is driven by a driving method using the normal driving.

In this figure, timing charts of elements corresponding to each of items “LI”, “G1” to “G4”, and “GD” are shown. The term “LI” indicates an emission timing of the optical pulse PO, light is emitted when the optical pulse PO is turned on, and no light is emitted when the optical pulse PO is turned off. The terms “G1” to “G4” indicate the accumulation timing of the readout gate transistors G1 to G4, charges are accumulated when the readout gate transistors G1 to G4 are turned on, and no charge is accumulated when the readout gate transistors G1 to G4 are turned off. The term “GD” indicates the driving timing of the drain gate transistor GD, and the charges are discharged when the drain gate transistor GD is turned on, and no charge is discharged when the drain gate transistor GD is turned off.

In the normal driving, an accumulation period and a readout period are provided in one frame. The accumulation period is a period during which charges are accumulated in the charge accumulation unit CS. The readout period is a period during which a pixel signal corresponding to the amount of charges accumulated in the charge accumulation unit CS is read out.

During the accumulation period, driving corresponding to unit accumulation is repeatedly performed the number N of times of integration. In the unit accumulation, the driving of sequentially accumulating charges in all the four charge accumulation units CS included in one pixel 321 is performed at an accumulation timing synchronized with the emission timing. For example, at the same timing as the emission timing at which the optical pulse PO is emitted, the drain gate transistor GD is turned off and the readout gate transistors G1 to G4 are sequentially turned on.

Specifically, the timing control unit 41 turns off the drain gate transistor GD and turns on the readout gate transistor G1, at the emission timing via the pixel drive circuit 322. After a specific accumulation time Ta (for example, the same time as an emission time To during which the optical pulse PO is emitted) has elapsed since the readout gate transistor G1 is turned on, the readout gate transistor G1 is turned off. The readout gate transistor G2 is turned on at a timing at which the readout gate transistor G1 is turned off. After the accumulation time Ta has elapsed since the readout gate transistor G2 is turned on, the readout gate transistor G2 is turned off. The readout gate transistor G3 is turned on at a timing at which the readout gate transistor G2 is turned off. After the accumulation time Ta has elapsed since the readout gate transistor G3 is turned on, the readout gate transistor G3 is turned off. The readout gate transistor G4 is turned on at a timing at which the readout gate transistor G3 is turned off. After the accumulation time Ta has elapsed since the readout gate transistor G4 is turned on, the readout gate transistor G4 is turned off and the drain gate transistor GD is turned on.

Here, the first HDR driving will be described with reference to FIG. 5. FIG. 5 is a diagram showing the first HDR driving performed by the distance image processing unit 4 according to the embodiment. FIG. 5 shows an example of a timing chart in which the pixel 321 is driven by a driving method using the first HDR driving.

In this figure, timing charts of elements corresponding to each of items “LI”, “G1” to “G4”, and “GD” are shown. The term “LI” indicates an emission timing of the optical pulse PO, light is emitted when the optical pulse PO is turned on, and no light is emitted when the optical pulse PO is turned off. The terms “G1” to “G4” indicate the accumulation timing of the readout gate transistors G1 to G4, charges are accumulated when the readout gate transistors G1 to G4 are turned on, and no charge is accumulated when the readout gate transistors G1 to G4 are turned off. The term “GD” indicates the driving timing of the drain gate transistor GD, and the charges are discharged when the drain gate transistor GD is turned on, and no charge is discharged when the drain gate transistor GD is turned off.

In the first HDR driving, the accumulation period and the readout period are provided in one frame, similarly to the normal driving. The accumulation period is a period during which charges are accumulated in the charge accumulation unit CS. The readout period is a period during which a pixel signal corresponding to the amount of charges accumulated in the charge accumulation unit CS is read out.

During the accumulation period, driving corresponding to unit accumulation is repeatedly performed the number N of times of integration. In the first HDR driving, a plurality of driving patterns (first driving pattern to fourth driving pattern) are executed for the unit accumulation.

Since the first driving pattern is the same driving pattern as normal driving, the description thereof will be omitted.

The second driving pattern is a driving pattern in which the readout gate transistor G1 is not turned on and the accumulation timing of each of the readout gate transistors G2 to G4 is the same timing as the first driving pattern. That is, the second driving pattern is a driving pattern in which no charge is accumulated in the charge accumulation unit CS1 corresponding to the readout gate transistor G1, in contrast to the first driving pattern (driving pattern of the normal driving).

Specifically, in the second driving pattern, the timing control unit 41 turns off the drain gate transistor GD and turns on the readout gate transistor G2 after the accumulation time Ta has elapsed from the emission timing, via the pixel drive circuit 322. After the accumulation time Ta has elapsed since the readout gate transistor G2 is turned on, the readout gate transistor G2 is turned off. The readout gate transistor G3 is turned on at a timing at which the readout gate transistor G2 is turned off. After the accumulation time Ta has elapsed since the readout gate transistor G3 is turned on, the readout gate transistor G3 is turned off. The readout gate transistor G4 is turned on at a timing at which the readout gate transistor G3 is turned off. After the accumulation time Ta has elapsed since the readout gate transistor G4 is turned on, the readout gate transistor G4 is turned off and the drain gate transistor GD is turned on.

The third driving pattern is a driving pattern in which the readout gate transistors G1 and G2 are not turned on and the accumulation timing of each of the readout gate transistors G3 and G4 is set to the same timing as the first driving pattern (driving pattern of the normal driving). That is, the third driving pattern is a driving pattern in which no charge is accumulated in the charge accumulation units CS1 and CS2 corresponding to the readout gate transistors G1 and G2, in contrast to the first driving pattern.

Specifically, in the third driving pattern, the timing control unit 41 turns off the drain gate transistor GD and turns on the readout gate transistor G3 after the accumulation time Ta×2 has elapsed from the emission timing, via the pixel drive circuit 322. After the accumulation time Ta has elapsed since the readout gate transistor G3 is turned on, the readout gate transistor G3 is turned off. The readout gate transistor G4 is turned on at a timing at which the readout gate transistor G3 is turned off. After the accumulation time Ta has elapsed since the readout gate transistor G4 is turned on, the readout gate transistor G4 is turned off and the drain gate transistor GD is turned on.

The fourth driving pattern is a driving pattern in which the readout gate transistors G1 to G3 are not turned on and the accumulation timing of only the readout gate transistor G4 is set to the same timing as the first driving pattern (driving pattern of the normal driving) That is, the fourth driving pattern is a driving pattern in which no charge is accumulated in the charge accumulation units CS1 to CS3 corresponding to the readout gate transistors G1 to G3, in contrast to the first driving pattern.

Specifically, in the fourth driving pattern, the timing control unit 41 turns off the drain gate transistor GD and turns on the readout gate transistor G4 after the accumulation time Ta×3 has elapsed from the emission timing, via the pixel drive circuit 322. After the accumulation time Ta has elapsed since the readout gate transistor G4 is turned on, the readout gate transistor G4 is turned off. The readout gate transistor G4 is turned off and the drain gate transistor GD is turned on.

In the first HDR driving, the number of times of integration for accumulating the charges corresponding to the reflected light in each of the charge accumulation units CS1 to CS4 included in the pixel 321 is different in one frame. The charge accumulation unit (for example, the charge accumulation unit CS4) that accumulates the charges of the reflected light RL coming from the subject present at a long distance is controlled such that the number of times of integration for accumulating charges is greater than that of the charge accumulation unit (for example, the charge accumulation unit CS1) that accumulates the charges of the reflected light RL coming from the subject OB present at a short distance.

Here, the second HDR driving will be described with reference to FIG. 6. FIG. 6 is a diagram showing the second HDR driving performed by the distance image processing unit 4 according to the embodiment. FIG. 6 shows an example of a timing chart in which the pixel 321 is driven by a driving method using the second HDR driving.

In this figure, timing charts of elements corresponding to each of items “LI”, “G1” to “G4”, and “GD” are shown. The term “LI” indicates an emission timing of the optical pulse PO, light is emitted when the optical pulse PO is turned on, and no light is emitted when the optical pulse PO is turned off. The terms “G1” to “G4” indicate the accumulation timing of the readout gate transistors G1 to G4, charges are accumulated when the readout gate transistors G1 to G4 are turned on, and no charge is accumulated when the readout gate transistors G1 to G4 are turned off. The term “GD” indicates the driving timing of the drain gate transistor GD, and the charges are discharged when the drain gate transistor GD is turned on, and no charge is discharged when the drain gate transistor GD is turned off.

In the second HDR driving, a plurality of sub-frames are provided in one frame. Each sub-frame is provided with the accumulation period and the readout period. The accumulation period is a period during which charges are accumulated in the charge accumulation unit CS. The readout period is a period during which a pixel signal corresponding to the amount of charges accumulated in the charge accumulation unit CS is read out.

In this figure, an example in which two sub-frames (a first sub-frame and a second sub-frame) are provided in one frame is shown. The first sub-frame is provided with a first sub-frame accumulation period and a first sub-frame readout period. The second sub-frame is provided with a second sub-frame accumulation period and a second sub-frame readout period.

In each sub-frame accumulation period, the driving corresponding to the unit accumulation is repeatedly performed the number of times of integration.

In the second HDR driving, the number of times of integration in each sub-frame accumulation period is set to a different number of times. That is, the number N1 of times of integration in the first sub-frame accumulation period and the number N2 of times of integration in the second sub-frame accumulation period are different from each other.

Since the driving pattern corresponding to the unit accumulation in each sub-frame is the same driving pattern as the normal driving, the description thereof will be omitted.

Here, the third HDR driving will be described with reference to FIG. 7. FIG. 7 is a diagram showing the third HDR driving performed by the distance image processing unit 4 according to the embodiment.

In the third HDR driving, the pixels 321 provided in the light receiving region 320 are classified into at least two groups, and are driven such that the number of times of integration of each group is different from each other.

As shown in this figure, for example, the pixels can be classified into even rows and odd rows in a pixel array arranged in a two-dimensional matrix in the light receiving region 320, as the classification of the groups. In this case, in the third HDR driving, the distance image processing unit 4 performs driving such that the number of times of integration per frame differs between a group to which a pixel group arranged in the even row belongs and a group to which a pixel group arranged in the odd row belongs.

Since the driving pattern in each group is the same as the normal driving, a description thereof will be omitted.

In the main measurement of the present embodiment, an appropriate driving method is selected in consideration of the advantages and disadvantages of the four driving methods (normal driving, first HDR driving, second HDR driving, and third HDR driving) and the results (the position and the reflectivity of each subject OB present in the measurement space) obtained in the pre-measurement.

Here, the advantages and disadvantages of the driving methods will be described.

First, advantages and disadvantages of the first HDR driving will be described.

It is known that the reflected light RL coming from the subject OB at a long distance is attenuated in proportion to the square of the distance. Therefore, in a case where the normal driving is performed, the smaller amount of the reflected light RL coming from the subject OB at a long distance than the amount of the reflected light RL coming from the subject OB at a short distance can be received.

On the other hand, in the first HDR driving, the number of times of integration for receiving the reflected light RL coming from the subject OB at a long distance can be made greater than the number of times of integration for receiving the reflected light RL coming from the subject OB at a short distance. Therefore, it is possible to receive each reflected light RL without saturating the reflected light RL coming from a short distance and without increasing the relative noise amount of the reflected light RL coming from a long distance. That is, the advantage of the first HDR driving is that measurement can be performed from a short distance to a long distance without reducing measurement accuracy.

In addition, in the first HDR driving, the number of times of integration for receiving the reflected light RL coming from the subject OB at a short distance can be reduced. Thus, it is another advantage of the first HDR driving that flare can be suppressed. The flare is a phenomenon in which the reflected light from the subject OB present at a short distance is re-reflected on a sensor surface, diffuse reflection occurs between a lens and a sensor, and noise that particularly reduces the accuracy of distance measurement of the object at a long distance appears.

On the other hand, in the first HDR driving, the number of times of integration for receiving the reflected light RL coming from each of the subjects OB present at the same distance cannot be set to a different number of times. Therefore, in a case where the reflectivity of the plurality of subjects OB present at the same distance in the measurement space is significantly different, the smaller amount of light received for the reflected light RL coming from the subject OB having a low reflectivity than the amount of the reflected light RL coming from the subject OB having a high reflectivity can be received. That is, the disadvantage of the first HDR driving is that it is difficult to accurately measure each subject OB of a plurality of subjects OB having significantly different reflectivities and present at the same distance. In addition, in the first HDR driving, the cycle time of one frame tends to be longer than that in the normal driving, which is also a disadvantage of the first HDR driving.

Next, advantages and disadvantages of the second HDR driving will be described.

In the second HDR driving, driving is performed with a different number of times of integration in units of frames or sub-frames. Therefore, in the second HDR driving, pixel resolution is not reduced compared to the third HDR driving. In addition, in the second HDR driving, measurement can be performed with the number of times of integration corresponding to the amount of the reflected light RL coming from each subject OB, and the number of times of integration for receiving the reflected light RL coming from each of the subjects OB present at the same distance can be set to a different number of times. That is, the advantage of the second HDR driving is that each of a plurality of subjects OB having significantly different reflectivities and present at the same distance can be accurately measured without reducing the pixel resolution.

Meanwhile, in the second HDR driving, a plurality of measurements (having different numbers of times of integration) are performed in units of frames or sub-frames. Therefore, the disadvantage of the second HDR driving is that the time required for measurement tends to be longer than that of the other driving methods (normal driving, first HDR driving, and third HDR). In addition, in the second HDR driving, the number of times of integration for receiving the reflected light RL coming from the subject OB at a short distance and the number of times of integration for receiving the reflected light RL coming from the subject OB at a long distance cannot be set to different numbers of times. Therefore, it is also a disadvantage of the second HDR driving that it is difficult to suppress the flare.

Then, advantages and disadvantages of the third HDR driving will be described.

In the third HDR driving, driving is performed with a different number of times of integration in units of pixels. Therefore, in the third HDR driving, a plurality of measurements having different numbers of times of integration can be completed by driving of one frame (or one sub-frame), and the time required for measurement can be reduced compared to the second HDR driving. In addition, in the third HDR driving, measurement can be performed with the number of times of integration corresponding to the amount of the reflected light RL coming from each subject OB, and the number of times of integration for receiving the reflected light RL coming from each of the subjects OB present at the same distance can be set to a different number of times. That is, the advantage of the third HDR driving is that it is possible to accurately measure each of a plurality of subjects OB having significantly different reflectivities and present at the same distance in one frame (or one sub-frame).

Meanwhile, in the third HDR driving, a plurality of measurements (having different numbers of times of integration) are performed in units of pixels. Therefore, a disadvantage of the third HDR driving is that the image resolution is lower than that of the other driving methods (normal driving, first HDR driving, and third HDR).

In addition, in the third HDR driving, the number of times of integration for receiving the reflected light RL coming from the subject OB at a short distance and the number of times of integration for receiving the reflected light RL coming from the subject OB at a long distance cannot be set to different numbers of times. Therefore, it is also a disadvantage of the third HDR driving that it is difficult to suppress the flare.

FIG. 8 is a diagram showing processing performed by the distance image processing unit 4 according to the embodiment. FIG. 8 schematically shows a plurality of subjects present in the measurement space of the distance image processing unit 4.

In this figure, the distance range SR is classified into a plurality of distance ranges SR1 to SR4. The distance range SR1 is a range divided into a short distance. The distance range SR2 is a range divided into a slightly short distance. The distance range SR3 is a range divided as a slightly long distance. The distance range SR4 is a range divided into a long distance.

In addition, the distance range SR corresponds to which two charge accumulation units CS among the four charge accumulation units CS included in the pixel 321 distribute and accumulate the charges corresponding to the reflected light RL in a case where the normal driving is performed. The distance range SR1 is a range in which the charges corresponding to the reflected light RL are distributed and accumulated in the charge accumulation units CS1 and CS2 in a case where the normal driving is performed. The distance range SR2 is a range in which the charges corresponding to the reflected light RL are distributed and accumulated in the charge accumulation units CS2 and CS3 in a case where the normal driving is performed. The distance range SR3 is a range in which the charges corresponding to the reflected light RL are distributed and accumulated in the charge accumulation units CS3 and CS4 in a case where the normal driving is performed. The distance range SR4 is a range in which the charges corresponding to the reflected light RL are distributed and accumulated in the charge accumulation unit CS4 in a case where the normal driving is performed.

In the normal driving shown in FIG. 4, the range corresponding to the distance range SR4 is not included in the measurement space. In a case where the distance range SR4 is included in the measurement space, the distance to the subject OB present in the range corresponding to the distance range SR4 can be measured, for example, by performing the range shift. The range shift is to move (shift) in a measurable range. For example, in the normal driving, the range shift can be performed by delaying the accumulation timing at which the readout gate transistors G1 to G2 are turned on by a fixed accumulation time Ta. In this case, the distance range SR2 is a range in which the charges corresponding to the reflected light RL are distributed and accumulated in the charge accumulation units CS1 and CS2. The distance range SR3 is a range in which the charges corresponding to the reflected light RL are distributed and accumulated in the charge accumulation units CS2 and CS3. The distance range SR4 is a range in which the charges corresponding to the reflected light RL are distributed and accumulated in the charge accumulation units CS3 and CS4. The distance range SR1 is not included in the measurement space. In the pre-measurement, the normal driving shown in FIG. 4 and the driving in which the normal driving is range-shifted are performed, so that measurement can be performed using the distance ranges SR1 to SR4 as the measurement space.

This figure shows that a subject OBA-1 having a reflectivity A is present in the distance range SR1 divided into the short distance. In addition, this figure shows that a subject OBA-2 having the reflectivity A and a subject OBB having a reflectivity B are present in the distance range SR2 divided into the slightly short distance. However, the reflectivity A and the reflectivity B are significantly different from each other, and the reflectivity A is much greater than the reflectivity B. In addition, this figure shows that a subject OBA-3 having the reflectivity A is present in the distance range SR3 divided into the slightly long distance. In addition, this figure shows that a subject OBA-4 having the reflectivity A is present in the distance range SR4 divided into the long distance.

In a case where the subject OB as shown in this figure is present in the measurement space, when the normal driving is performed by setting the integration time to be small, the amount of the reflected light RL coming from the subject OBB having a small reflectivity, the subjects OBA-3 and OBA-4 at a long distance, and the like is insufficient, and it is difficult to measure the subjects with high accuracy. On the other hand, when the normal driving is performed by setting the integration time to be large, the amount of the reflected light RL coming from the subjects OBA-1, OBA-2, and the like at a short distance is saturated, and it is difficult to measure the subjects.

In the first HDR driving, it is possible to measure each of the subjects OBA-1 to OBA-4 present in the measurement space in this figure in one frame without decreasing the measurement accuracy, whereas it is difficult to measure both the subject OBA-2 and the subject OBB without decreasing the measurement accuracy.

In the second HDR driving, it is possible to measure each subject without reducing the measurement accuracy by performing the measurement according to the number of times of integration corresponding to each of the subjects OBA-1 to OBA-4 and OBB present in the measurement space in this figure. However, the measurement time is increased compared to a case where the other driving methods (normal driving, first HDR driving, and third HDR driving) are performed. In addition, the suppression of the flare cannot be expected.

In the third HDR driving, it is possible to measure each subject without reducing the measurement accuracy by performing the measurement by the number of times of integration corresponding to each of the subjects OBA-1 to OBA-4 and OBB present in the measurement space in this figure. However, the image resolution is lower than that in a case where the other driving methods (normal driving, first HDR driving, and third HDR driving) are performed. In addition, the suppression of the flare cannot be expected.

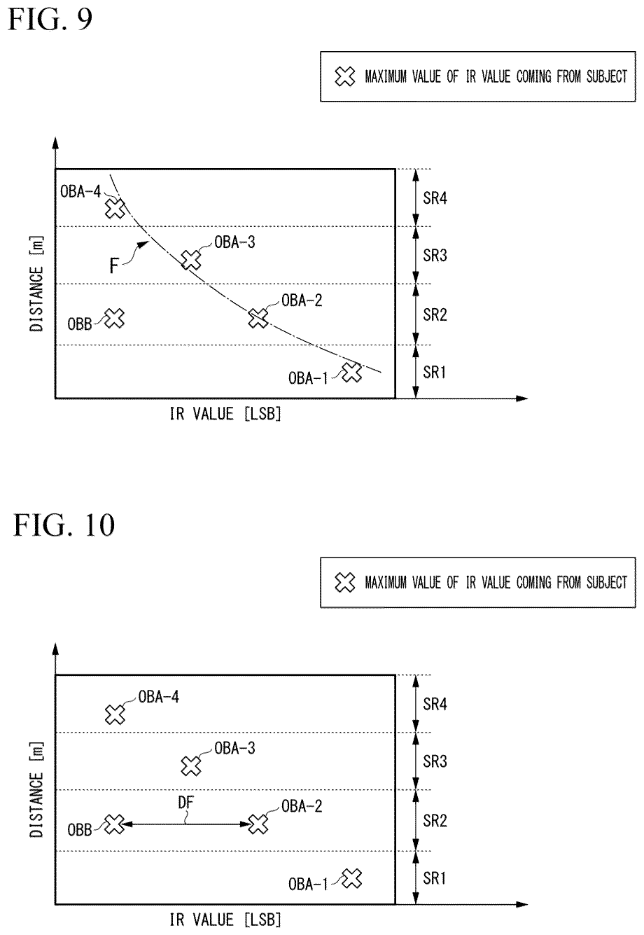

Here, the processing of selecting a driving method in the main measurement will be described with reference to FIGS. 9 to 11.

The distance image processing unit 4 determines whether or not a plurality of subjects OB are present in the measurement space. In a case where a plurality of subjects OB are present in the measurement space, the distance image processing unit 4 classifies the plurality of subjects OB into subjects OB having the same degree of reflectivity and the other subjects OB.

FIG. 9 is a diagram showing the processing performed by the distance image processing unit 4 according to the embodiment. FIG. 9 schematically shows a relationship between an IR value and a distance in the subjects (subjects OBA-1 to OBA-4 and OBB) shown in FIG. 8. The IR value here is a value corresponding to the amount of infrared light (reflected light of an optical pulse emitted from the light source device 21) received by the pixel 321 in the pre-measurement. The distance here can be calculated based on the ratio of the amount of charges corresponding to the reflected light RL accumulated in each of the charge accumulation units CS included in the pixel 321 in the pre-measurement.

For example, the distance image processing unit 4 first generates an IR image based on the amount of infrared light received by the pixel 321 by the pre-measurement. The IR image is an image in which the amount of infrared light (optical pulse emitted by the light source device 21) received by the pixel 321 is shown as a pixel value. The distance image processing unit 4 performs object recognition by applying image processing to the generated IR image and specifies the subject OB present in the measurement space. The distance image processing unit 4 calculates a representative IR value (for example, a maximum value) of the subject OB from the IR value of each of the pixel groups corresponding to the subject OB present in the measurement space in the IR image. The distance image processing unit 4 calculates a representative IR value (for example, a maximum value) of each of the plurality of subjects OB present in the measurement space.

Next, the distance image processing unit 4 calculates the distance to the subject OB present in the measurement space. In the pre-measurement, the distance image processing unit 4 calculates the distance to the subject OB by applying Expression (1) to the amount of the charges accumulated in each of the charge accumulation units CS included in the pixel 321. The distance image processing unit 4 calculates a representative distance (for example, a maximum value) of the subject OB from the distance indicated by each of the pixel groups corresponding to the subject OB. The distance image processing unit 4 calculates a representative distance (for example, a maximum value) of each of the plurality of subjects OB present in the measurement space.

Then, the distance image processing unit 4 determines whether or not each of the plurality of subjects OB present in the measurement space is a subject having the same degree of reflectivity from the relationship between the representative IR value and the representative distance obtained for each subject OB. The distance image processing unit 4 determines that the subjects OB having a relationship in which the IR value decreases in a relationship that is inversely proportional to the square of the distance are subjects having the same degree of reflectivity. On the other hand, the distance image processing unit 4 determines that the subjects OB having no relationship in which the IR value decreases in the relationship that is inversely proportional to the square of the distance are subjects having reflectivities different from each other.

For example, as shown in FIG. 9, the distance image processing unit 4 plots coordinate values corresponding to the representative IR value and the representative distance obtained for each subject OB on a graph in which the horizontal axis represents the IR value and the vertical axis represents the distance. The distance image processing unit 4 calculates an approximate curve of the plotted point group of the subjects OB. In a case where the calculated approximate curve is expressed by a function in which the IR value is expressed by a quadratic function of the distance, the subjects OB having coordinate values along the approximate curve are determined to be subjects having the same degree of reflectivity. On the other hand, the subjects OB having coordinate values at positions deviating from the approximate curve are determined not to be subjects having the same degree of reflectivity.

Whether a plotted point is along or out of the approximate curve can be determined, for example, in accordance with a distance (minimum distance) between the approximate curve and the plotted point. For example, in a case where the minimum distance is less than a threshold value, it is determined that the point is along the approximate curve. On the other hand, in a case where the minimum distance is equal to or greater than the threshold value, it is determined that the point is out of the approximate curve.

In the example of FIG. 9, the distance image processing unit 4 plots coordinates corresponding to each of the subjects OBA-1 to OBA-4 and OBB, and calculates an approximate curve F of the plotted point group. It is determined that the subjects OBA-1 to OBA-4 corresponding to the point group along the approximate curve F are subjects having the same degree of reflectivity. On the other hand, it is determined that the subject OBB deviating from the approximate curve F is not a subject having the same degree of reflectivity.

In a case where a plurality of subjects OB having the same degree of reflectivity are present in the measurement space, the distance image processing unit 4 selects the first HDR driving for measurement of each of the plurality of subjects OB having the same degree of reflectivity. In the example of FIG. 9, since it is determined that the subjects OBA-1 to OBA-4 are subjects having the same degree of reflectivity, the first HDR driving is selected for measurement of each of the subjects OBA-1 to OBA-4.

In a case where a plurality of subjects OB having different reflectivities are present in the measurement space, the distance image processing unit 4 determines whether or not the plurality of subjects OB are present in the same distance range SR. In the pre-measurement, the distance image processing unit 4 determines whether or not a plurality of subjects OB having different reflectivities are present in the same distance range SR, depending on which two charge accumulation units CS among the four charge accumulation units CS included in the pixel 321 corresponding to the subject OB accumulate the charges corresponding to the reflected light RL.

FIG. 10 is a diagram showing the processing performed by the distance image processing unit 4 according to the embodiment. FIG. 10 schematically shows a relationship between the IR value and the distance in the subjects (subjects OBA-1 to OBA-4 and OBB) shown in FIG. 8, similarly to FIG. 9. This figure shows that the subjects OBA-2 and OBB are present in the same distance range SR2.

In a case where two subjects OB having different reflectivities are present in the same distance range SR, the distance image processing unit 4 determines whether to measure both subjects OB simultaneously by one driving method or to measure each subject OB separately by each driving method in accordance with the magnitude of a difference in reflectivities between the two subjects OB.

In this figure, the difference between the representative IR values of the subjects OBA-2 and OBB is a difference DF.

The distance image processing unit 4 calculates, for example, the difference DF between the representative IR values of the subjects OB as a value corresponding to the difference in reflectivities. In a case where the difference DF between the representative IR values is less than a threshold value, the distance image processing unit 4 determines that both the subjects OB are simultaneously measured by one driving method. On the other hand, in a case where the difference DF between the representative IR values is equal to or greater than the threshold value, the distance image processing unit 4 determines that each subject OB is separately measured by each driving method. The threshold value here is determined in advance in accordance with the maximum value or the like of the amount of charges that can be accumulated by the charge accumulation unit CS.

In a case where it is determined to separately measure each subject OB by each driving method, the distance image processing unit 4 selects the second HDR driving or the third HDR driving for the measurement of at least one subject OB. By performing the second HDR driving or the third HDR driving in which an appropriate number of times of integration is set in accordance with the amount of the reflected light RL coming from the subject OB to be measured, the subject OB can be measured with high accuracy. Whether to select the second HDR driving or the third HDR driving can be selected depending on, for example, which of the measurement time and the image resolution is prioritized.

In this figure, in a case where the difference DF is equal to or greater than the threshold value, the distance image processing unit 4 selects the first HDR driving for the measurement of the subject OBA-2. Therefore, for the measurement of the subject OBB, the subject OBB is not a target to be measured by the first HDR driving, and the second HDR driving or the third HDR driving is selected.

In a case where a plurality of subjects OB having different reflectivities are present in the measurement space, the distance image processing unit 4 determines whether or not the subjects OB are in a combination in which the first HDR driving is not appropriate. The combination in which the first HDR driving is not appropriate is a combination in which the subject OB having a high reflectivity is present at a long distance and the subject OB having a low reflectivity is present at a short distance.

The first HDR driving is driving based on the premise that the amount of the reflected light RL coming from the subject OB present at a long distance is smaller than the amount of the reflected light RL coming from the subject OB present at a short distance. Therefore, in a case where the amount of the reflected light RL coming from the subject OB present at a long distance is greater than or equal to the amount of the reflected light RL coming from the subject OB present at a short distance, it is not appropriate to select the first HDR driving.

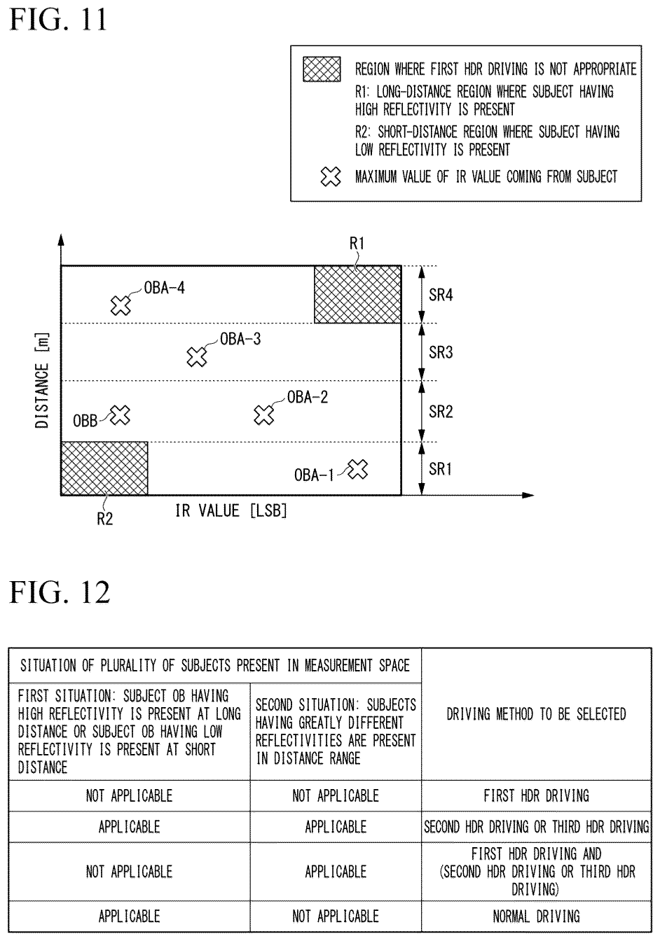

FIG. 11 is a diagram showing the processing performed by the distance image processing unit 4 according to the embodiment. FIG. 11 schematically shows a relationship between the IR value and the distance in the subjects (subjects OBA-1 to OBA-4 and OBB) shown in FIG. 8, similarly to FIG. 9. This figure shows regions R1 and R2 where it is not appropriate to select the first HDR driving. The region R1 is a region plotted in a case where the subject OB having a high reflectivity is present at a long distance. The region R2 is a region plotted in a case where the subject OB having a low reflectivity is present at a short distance.

In a case where the two subjects OB having different reflectivities are a combination for which the first HDR driving is not appropriate, the distance image processing unit 4 does not measure the two subjects OB by the HDR driving (first HDR driving, second HDR driving, and third HDR driving), but measures the two subjects OB by the normal driving.

In a case where the amount of the reflected light RL coming from the subject OB present at a long distance is approximately the same as the amount of the reflected light RL coming from the subject OB present at a short distance, both the subjects OB can be accurately measured by selecting the normal driving.

Here, a relationship between the situation of the subject OB and the driving method selected according to the situation of the subject OB will be described with reference to FIG. 12. FIG. 12 is a diagram showing the processing performed by the distance image capturing device 1 according to the embodiment.

In this figure, the situation of the subject OB is a situation (first situation) in which the subject OB having a high reflectivity is present at a long distance or the subject OB having a low reflectivity is present at a short distance, and a situation (second situation) in which subjects having a large difference in reflectivities are present in a distance range.

The distance image processing unit 4 selects a driving method for measuring the subject OB depending on a combination of whether or not the first situation applies and whether or not the second situation applies.

In a case where neither the first situation nor the second situation applies, the distance image processing unit 4 selects the first HDR driving as a driving method of (collectively) measuring the plurality of subjects OB present in the measurement space. This is because it can be estimated that the reflectivities of the plurality of subjects OB present in the measurement space are all approximately the same since neither the first situation nor the second situation applies.

In a case where both the first situation and the second situation applies, the distance image processing unit 4 selects the second HDR driving or the third HDR driving as a driving method of (separately) measuring the plurality of subjects OB present in the measurement space. This is because it is difficult to collectively measure a plurality of subjects OB that apply to the second situation with the same number of times of integration.

In a case where the first situation does not apply but the second situation applies, the distance image processing unit 4 selects the first HDR driving and either one of the second HDR driving or the third HDR driving as driving methods of measuring the plurality of subjects OB present in the measurement space. This is because the measurement by the first HDR driving can be performed on the subject OB that does not apply to the first situation, and it is difficult to collectively measure the plurality of subjects OB that apply to the second situation with the same number of times of integration.

In a case where the first situation applies but the second situation does not apply, the distance image processing unit 4 selects the normal driving as a driving method of (collectively) measuring the plurality of subjects OB present in the measurement space. This is because, since the first situation applies, the measurement by the first HDR driving is not appropriate and it is more appropriate to adopt the normal driving as a method of (collectively) measuring the plurality of subjects OB.

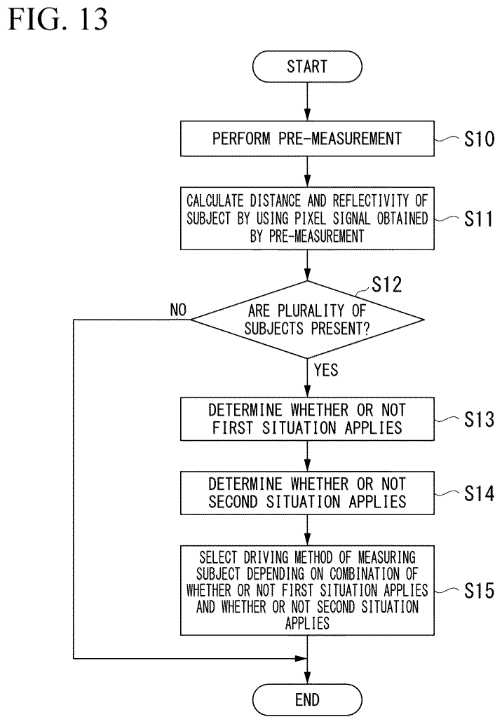

Here, an example of a flow of the processing performed by the distance image capturing device 1 will be described with reference to FIG. 13. FIG. 13 is a flowchart showing a flow of the processing performed by the distance image capturing device 1 according to the embodiment. First, the distance image capturing device 1 performs pre-measurement (step S10). The distance image capturing device 1 performs, for example, a plurality of measurements having different numbers of times of integration in the pre-measurement. The distance image capturing device 1 may perform a plurality of measurements having different numbers of times of integration by the second HDR driving or the third HDR driving, or may perform a plurality of measurements having different numbers of times of integration by the normal driving. In addition, in the pre-measurement, measurement may be performed using the distance ranges SR1 to SR4 as the measurement space by performing the normal driving shown in FIG. 4 and the driving in which the normal driving is range-shifted. The distance image processing unit 4 may perform the pre-measurement using a driving method in which at least the distance and the relative reflectivity of each of the plurality of subjects OB present in the measurement space can be determined.

Next, the distance image processing unit 4 calculates the distance to the subject OB and the reflectivity of the subject OB, using a pixel signal obtained by the pre-measurement (step S11). The distance image processing unit 4 determines whether or not a plurality of subjects OB are present in the measurement space (step S12).

In a case where a plurality of subjects OB are present in the measurement space, the distance image processing unit 4 determines whether or not the situation of the plurality of subjects OB present in the measurement space applies to the first situation (step S13). In addition, in a case where a plurality of subjects OB are present in the measurement space, the distance image processing unit 4 determines whether or not the situation of the plurality of subjects OB present in the measurement space applies to the second situation (step S14).

Then, the distance image processing unit 4 selects a driving method of measuring a subject depending on a combination of whether or not the first situation applies and whether or not the second situation applies (step S15).

In the present flowchart, the flow of determining whether or not the first situation and the second situation apply is shown in this order, but the present disclosure is not limited thereto. Whether or not the second situation and the first situation applies may be determined in this order.

In the first HDR driving, in a case where a plurality of subjects OB having significantly different reflectivities are present in the same distance range SR, the number of times of integration suitable for the reflectivity of any one subject OB can be set. Therefore, it is difficult to collectively measure all the subjects OB having individual reflectivities.

Therefore, in a case where the situation of the subject OB present in the measurement space applies to the second situation, it is effective to perform the measurement not only by the first HDR driving but also the measurement by a combination of the first HDR driving and the second HDR driving or the third HDR driving.

The driving in which the first HDR driving and the second HDR driving or the third HDR driving are combined is driving (referred to as first combination driving) in which the first HDR driving and the second HDR driving are combined or driving (referred to as second combination driving) in which the first HDR driving and the third HDR driving are combined.

The first combination driving is driving in which a driving pattern corresponding to the unit accumulation in the second HDR driving is replaced with a driving pattern corresponding to the unit accumulation in the first HDR driving.

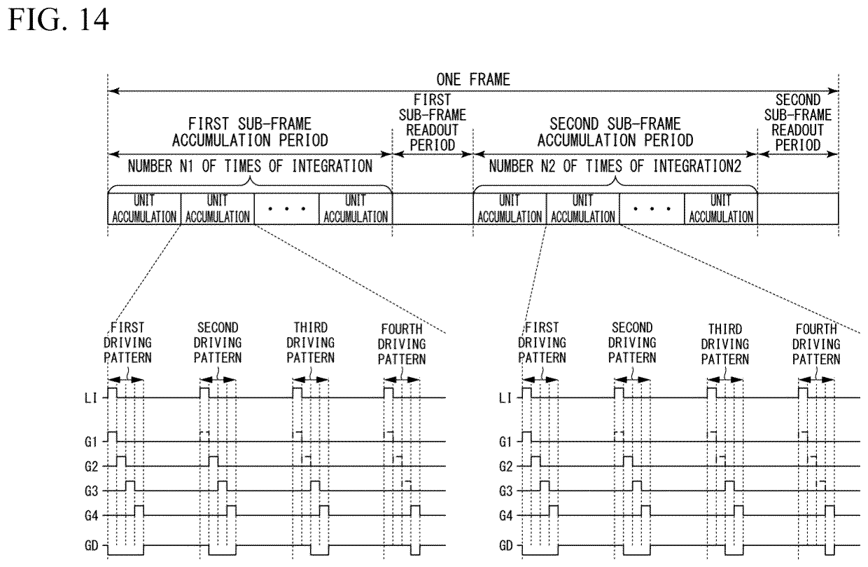

FIG. 14 is a diagram showing the first combination driving performed by the distance image processing unit 4 according to the embodiment. FIG. 14 shows an example of a timing chart in which the pixel 321 is driven by a driving method using the first combination driving.

In this figure, since the elements corresponding to each of the items of “LI”, “G1” to “G4”, “GD”, “accumulation period”, “readout period”, “first sub-frame”, “first sub-frame accumulation period”, “first sub-frame readout period”, “second sub-frame”, “second sub-frame accumulation period”, and “second sub-frame readout period” are the same as those in FIG. 6, the description thereof will be omitted.

In the first combination driving, similarly to the second HDR driving, the number of times of integration in each sub-frame accumulation period is set to a different number of times, and a driving pattern corresponding to the unit accumulation in each sub-frame is a driving pattern corresponding to the unit accumulation of the first HDR driving as shown in FIG. 5.

In the second combination driving, similarly to the third HDR driving, the pixels 321 provided in the light receiving region 320 are classified into a plurality of groups and are driven such that the number of times of integration in each group is set to a different number of times, and then, a driving pattern corresponding to the unit accumulation in each group is set to a driving pattern corresponding to the unit accumulation of the first HDR driving as shown in FIG. 5.

In addition, in a case where the subject OB having a high reflectivity is present at a long distance or the subject OB having a low reflectivity is present at a short distance, there is a high possibility that a sufficient amount of light cannot be received for the reflected light RL coming from any subject OB in the first HDR driving, and it is difficult to perform measurement with high accuracy.

Therefore, in a case where the situation of the subject OB present in the measurement space applies to the first situation, it is effective to perform measurement by the normal driving, or either one of the second HDR driving or the third HDR driving, instead of the first HDR driving. In a case where measurement is performed by the normal driving, the subject OB having a high reflectivity present at a long distance and the subject OB having a low reflectivity present at a short distance can be collectively measured. In a case where measurement is performed by the second HDR driving or the third HDR driving, the measurement by the number of times of integration according to the reflectivity of the subject OB having a high reflectivity present at a long distance and the measurement by the number of times of integration according to the reflectivity of the subject OB having a low reflectivity present at a short distance are performed separately.

As described above, the distance image capturing device 1 according to a first embodiment includes the light source unit 2, the light receiving unit 3, and the distance image processing unit 4. The distance image processing unit 4 performs the pre-measurement using a driving method capable of calculating the distance and the reflectivity of the subject OB present in the measurement space. The distance image processing unit 4 calculates the distance and the reflectivity of the subject OB present in the measurement space based on the measurement result of the pre-measurement. The distance image processing unit 4 performs the main measurement based on a relationship between the distance and the reflectivity of the subject OB present in the measurement space. In the main measurement, the distance image processing unit 4 selects whether to perform high dynamic range (HDR) driving (any of first HDR driving, second HDR driving, or third HDR driving) that expands the measurement range or to perform the normal driving that does not expand the measurement range.

Accordingly, in the distance image capturing device 1 according to the embodiment, since an appropriate driving method can be selected based on the relationship between the distance and the reflectivity of the subject OB, the HDR driving can be appropriately used.

All or a part of the distance image capturing device 1 and the distance image processing unit 4 in the above-described embodiment may be implemented by a computer. In this case, a program for implementing the functions may be recorded on a computer-readable recording medium, and a computer system may read and execute the program recorded on the recording medium to implement the functions. The “computer system” referred to herein includes an OS and hardware such as peripherals. Additionally, the term “computer-readable recording medium” refers to a portable medium such as a flexible disk, a magneto-optical disk, a ROM, or a CD-ROM, or a storage device such as a hard disk incorporated into the computer system. Furthermore, the computer-readable recording medium may include a medium that dynamically stores a program for a short time, like a communication line when the program is transmitted via a network such as the Internet or a communication line such as a telephone line, and a medium that stores a program for a predetermined time, like a volatile memory in a computer system serving as a server or a client in that case. In addition, the program may be a program for implementing some of the above-described functions, and the above-described functions may be implemented by combination with a program recorded in advance in a computer system, or may be implemented by using a programmable logic device such as FPGA.

While preferred embodiments of the invention have been described and illustrated above, it should be understood that these are exemplary of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

What is claimed is:

1. A distance image capturing device comprising:
a light source unit configured to emit an optical pulse to a measurement space;
a light receiving unit including:
a pixel circuit in which a plurality of pixels are arranged in a two-dimensional matrix, the pixels each having a photoelectric conversion element that generates charges according to incident light and a plurality of charge accumulation units that accumulate the charges, and
a pixel drive circuit that distributes and accumulates the charges in each of the charge accumulation units at a predetermined accumulation timing synchronized with an emission timing at which the optical pulse is emitted; and
a distance image processing unit configured to calculate a distance to a subject present in the measurement space based on an amount of the charges accumulated in each of the charge accumulation units,
wherein the distance image processing unit
performs pre-measurement by a driving method that allows calculation of the distance and a reflectivity of the subject present in the measurement space,
calculates the distance to the subject and the reflectivity of the subject as a situation of the subject present in the measurement space based on a measurement result of the pre-measurement,
performs main measurement based on the situation of the subject present in the measurement space, and
selects, in the main measurement, whether to perform high dynamic range (HDR) driving that expands a measurement range or to perform normal driving that does not expand the measurement range, based on the situation.

2. The distance image capturing device according to claim 1,
wherein the distance image processing unit performs, in the pre-measurement, a plurality of measurements, each of which has a different number of times of integration for repeating processing of accumulating the charges in each of the charge accumulation units.

3. The distance image capturing device according to claim 2,
wherein the distance image processing unit calculates relative reflectivities of a plurality of subjects including the subject present in the measurement space as the situation based on the measurement result of the pre-measurement.

4. The distance image capturing device according to claim 3,
wherein the distance image processing unit determines whether or not a difference in reflectivities between the plurality of the subjects present in the measurement space is equal to or greater than a threshold value as the situation based on the measurement result of the pre-measurement.

5. The distance image capturing device according to claim 2,
wherein the distance image processing unit determines whether or not the subject having a low reflectivity is present at a short distance and the subject having a high reflectivity is present at a long distance in the measurement space as the situation based on a measurement result of the pre-measurement.

6. The distance image capturing device according to claim 1,
wherein the HDR driving includes first HDR driving in which, among the plurality of charge accumulation units included in the pixels, a charge accumulation unit that accumulates the charges at the accumulation timing at which reflected light coming from the subject at a long distance is received has a greater number of times for receiving the reflected light in one frame than a charge accumulation unit that accumulates the charges at the accumulation timing at which the reflected light coming from the subject at a short distance is received.

7. The distance image capturing device according to claim 1,
wherein the HDR driving includes second HDR driving
that repeats a unit accumulation of sequentially accumulating the charges in the plurality of charge accumulation units included in the pixels in one frame and
that drives to have a different number of times of integration for repeating the unit accumulation for each frame.

8. The distance image capturing device according to claim 1,
wherein the HDR driving includes third HDR driving
that repeats a unit accumulation of sequentially accumulating the charges in the plurality of charge accumulation units included in the pixels in one frame and
that drives to have a different number of times of integration for repeating the unit accumulation for each of the pixels.

9. The distance image capturing device according to claim 1,
wherein the situation includes a first situation and a second situation,
the distance image processing unit determines whether or not the first situation applies and whether or not the second situation applies, based on the measurement result of the pre-measurement,
the first situation is a situation in which the subject having a low reflectivity is present at a short distance in the measurement space or the subject having a high reflectivity is present at a long distance in the measurement space,
the second situation is a situation in which the subjects including the subject having a difference in reflectivities equal to or greater than a threshold value is present at the same measurement range,
in a case where the first situation does not apply and the second situation does not apply, first HDR driving is selected as the HDR driving in the main measurement, and
the first HDR driving is a driving method in which, among the plurality of charge accumulation units included in the pixels, a charge accumulation unit that accumulates the charges at the accumulation timing at which reflected light coming from the subject at a long distance is received has a greater number of times for receiving the reflected light in one frame than a charge accumulation unit that accumulates the charges at the accumulation timing at which the reflected light coming from the subject at a short distance is received.

10. The distance image capturing device according to claim 1,
wherein the situation includes a first situation and a second situation,
the distance image processing unit determines whether or not the first situation applies and whether or not the second situation applies, based on the measurement result of the pre-measurement,
the first situation is a situation in which the subject having a low reflectivity is present at a short distance in the measurement space or the subject having a high reflectivity is present at a long distance in the measurement space,
the second situation is a situation in which the subjects including the subject having a difference in reflectivities equal to or greater than a threshold value is present at the same measurement range,
in a case where the first situation applies and the second situation applies, second HDR driving or third HDR driving is selected as the HDR driving in the main measurement,
the second HDR driving is a driving method of
repeating unit accumulation of sequentially accumulating the charges in the plurality of charge accumulation units included in the pixels in one frame and
driving to have a different number of times of integration for repeating the unit accumulation for each frame, and
the third HDR driving is a driving method of driving to have a different number of times of integration for repeating the unit accumulation for each of the pixels.

11. The distance image capturing device according to claim 1,
wherein the situation includes a first situation and a second situation,
the distance image processing unit determines whether or not the first situation applies and whether or not the second situation applies, based on the measurement result of the pre-measurement,
the first situation is a situation in which the subject having a low reflectivity is present at a short distance in the measurement space and the subject having a high reflectivity is present at a long distance in the measurement space,
the second situation is a situation in which the subjects including the subject having a difference in reflectivities equal to or greater than a threshold value is present at the same measurement range,
in a case where the first situation does not apply and the second situation applies, first HDR driving and either one of second HDR driving or third HDR driving are selected as the HDR driving in the main measurement,
the first HDR driving is a driving method in which, among the plurality of charge accumulation units included in the pixels, a charge accumulation unit that accumulates the charges at the accumulation timing at which reflected light coming from the subject at a long distance is received has a greater number of times for receiving the reflected light in one frame than a charge accumulation unit that accumulates the charges at the accumulation timing at which the reflected light coming from the subject at a short distance is received,
the second HDR driving is a driving method of
repeating unit accumulation of sequentially accumulating the charges in the plurality of charge accumulation units included in the pixels in one frame and
driving to have a different number of times of integration for repeating the unit accumulation for each frame, and
the third HDR driving is a driving method of driving to have a different number of times of integration for repeating the unit accumulation for each of the pixels.

12. The distance image capturing device according to claim 1,
wherein the situation includes a first situation and a second situation,
the distance image processing unit determines whether or not the first situation applies and whether or not the second situation applies, based on the measurement result of the pre-measurement,
the first situation is a situation in which the subject having a low reflectivity is present at a short distance in the measurement space or the subject having a high reflectivity is present at a long distance in the measurement space,
the second situation is a situation in which the subjects including the subject having a difference in reflectivities equal to or greater than a threshold value is present at the same measurement range,
in a case where the first situation applies and the second situation does not apply, the normal driving is selected in the main measurement, and
the normal driving is a driving method of
repeating unit accumulation of sequentially accumulating the charges in the plurality of charge accumulation units included in the pixels in one frame and
driving to have the same number of times of integration for repeating the unit accumulation regardless of the pixels and the frame.

13. A distance image capturing method using a distance image capturing device including:
a light source unit configured to emit an optical pulse to a measurement space;
a light receiving unit including a pixel circuit in which a plurality of pixels are arranged in a two-dimensional matrix, the pixels each having a photoelectric conversion element that generates charges according to incident light and a plurality of charge accumulation units that accumulate the charges, and a pixel drive circuit that distributes and accumulates the charges in each of the charge accumulation units at a predetermined accumulation timing synchronized with an emission timing at which the optical pulse is emitted; and
a distance image processing unit configured to calculate a distance to a subject present in the measurement space based on an amount of the charges accumulated in each of the charge accumulation units,
wherein the distance image processing unit
performs pre-measurement by a driving method that allows calculation of the distance and a reflectivity of the subject present in the measurement space,
calculates the distance to the subject and the reflectivity of the subject as a situation of the subject present in the measurement space based on a measurement result of the pre-measurement,
performs main measurement based on the situation of the subject present in the measurement space, and
selects, in the main measurement, whether to perform high dynamic range (HDR) driving that expands a measurement range or to perform normal driving that does not expand the measurement range, based on the situation.

14. A distance image capturing device comprising:
a light source unit configured to emit an optical pulse to a measurement space;
a light receiving unit including:
a pixel circuit in which a plurality of pixels are arranged in a two-dimensional matrix, the pixels each having a photoelectric conversion element that generates charges according to incident light and a plurality of charge accumulation units that accumulate the charges, and
a pixel drive circuit that distributes and accumulates the charges in each of the charge accumulation units at a predetermined accumulation timing synchronized with an emission timing at which the optical pulse is emitted; and
a distance image processing unit configured to calculate a distance to subjects present in the measurement space based on an amount of the charges accumulated in each of the charge accumulation units,
wherein the distance image processing unit
performs pre-measurement by a driving method that allows calculation of the distance and a reflectivity of the subjects present in the measurement space,
calculates the distance to the subjects and the reflectivity of the subjects as a situation of the subjects present in the measurement space based on a measurement result of the pre-measurement,
performs main measurement based on the situation of the subjects present in the measurement space, and
selects, in the main measurement, whether to perform high dynamic range (HDR) driving that expands a measurement range or to perform normal driving that does not expand the measurement range, based on the situation, and
the distance image processing unit
performs, in the pre-measurement, a plurality of measurements, each of which has a different number of times of integration for repeating processing of accumulating the charges in each of the charge accumulation units,
calculates relative reflectivities of the subjects present in the measurement space based on the measurement result of the pre-measurement, and
determines, as the situation, whether or not a difference in reflectivities between the subjects present in the measurement space is equal to or greater than a threshold value,
whether or not a subject included in the subjects having a low reflectivity is present at a short distance, and
whether or not a subject included in the subjects having a high reflectivity is present at a long distance in the measurement space.
